(19) United States
(12) Patent Application Publication
(10) Pub. No.: US 2020/0338920 A1
(43) Pub. Date: Oct. 29, 2020

(54) FABRIC PRINTABLE MEDIUM

(71) Applicant: Hewlett-Packard Development Company, L.P., Spring, TX (US)

(72) Inventors: Xulong Fu, San Diego, CA (US); Xiaoqi Zhou, San Diego, CA (US)

(21) Appl. No.: 16/768,565

(22) PCT Filed: Mar. 19, 2018
(86) PCT No.: PCT/US2018/023131

§ 371 Date: May 29, 2020

(51) Int. Cl. B41M 5/50; B41M 5/52; C09D 11/322; C09D 11/037; C09D 11/107; C09D 11/102; C09D 11/104; D06P 5/30; D06P 5/08; D06P 1/52

(52) U.S. Cl. CPC B41M 5/508; D06P 3/526; B41M 5/5281; B41M 5/5272; B41M 5/5254; C09D 11/322; C09D 11/037; C09D 11/107; C09D 11/102; C09D 11/104; D06P 5/30; D06P 5/08; D06P 1/525; D06P 1/5271; D06P 1/5285; B41M 2205/34; B41M 2205/36; B41M 5/5218

(57) ABSTRACT

A fabric printable medium includes a fabric base substrate having an image-side and a back-side. The fabric printable medium also includes a flame retardant ink receiving layer on the image-side of the fabric base substrate. The flame retardant ink receiving layer includes a first crosslinked polymeric network, a second crosslinked polymeric network, a flame retardant agent, and a physical networking agent selected from the group consisting of an acrylate copolymer, a polyacrylic acid copolymer, a polyester copolymer, a polyurethane copolymer, and combinations thereof, the physical networking agent having a weight average molecular weight ranging from 300,000 Mw to 1,000,000 Mw. The fabric printable medium also includes a waterproof coating on the back-side of the fabric base substrate.

### BACKGROUND

The application of inkjet printing technology has been expanded to large format, high-speed, commercial and industrial printing, in addition to home and office usage, because of its ability to produce economical, high quality, multi-colored prints. This technology is a non-impact printing method in which an electronic signal controls and directs droplets or a stream of ink that can be deposited on a wide variety of medium substrates. Inkjet printing technology has been used on different substrates including, for examples, cellulose paper, metal, plastic, fabric/textile, and the like. The substrate plays a key role in the overall image quality and permanence of the printed images. Textile printing has various applications including the creation of signs, banners, artwork, apparel, wall coverings, window coverings, upholstery, pillows, blankets, flags, tote bags, etc.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a schematic and cross-sectional view of an example of the fabric printable medium disclosed herein;

FIG. 2 is a schematic and cross-sectional view of another example of the fabric printable medium disclosed herein;

FIG. 3 is a schematic and cross-sectional view of yet another example of the fabric printable medium disclosed herein;

FIG. 4 is a flow diagram illustrating an example of a method for forming an example of the fabric printable medium; and

FIG. 5 is a flow diagram illustrating an example of a printing method disclosed herein.

### DETAILED DESCRIPTION

When printing on fabric substrates, challenges exist due to the specific nature of fabric. Some fabrics, for instance, can be highly absorptive of aqueous inks, which can diminish color characteristics of the printed image. Other fabrics, such as some synthetic fabrics, can be crystalline, and thus are less absorptive of aqueous inks. When the inks are not adequately absorbed, performance issues can result. These characteristics (e.g., diminished color, ink bleed) can result in poor image quality on the respective fabrics. Additionally, black optical density, color gamut, and sharpness of the printed images can be affected, and are often worse on fabrics when compared to images printed on cellulose paper or other media types. Durability, such as scratch resistance, rub resistance, and folding resistance, is another concern when printing on fabric, particularly when pigmented inks are used. Furthermore, when the fabric is intended to be used in close proximity to indoor environments (as drapes, as overhead signage, as part of furnishings, or the like) or is to be illuminated (e.g., frontlit), there are concerns about flame resistance as well as about using coatings that increase the flammability of the fabric.

The fabric printable medium disclosed herein is a printable recording medium (or printable media) that generates high quality printed images, that exhibits outstanding print durability, in terms of scratch resistance, rub resistance, and folding resistance, and that also exhibits fire or flame retardance.

By “scratch resistance” and “rub resistance”, it is meant herein that the image printed on the medium is resistant to degradation as a result of scuffing or abrasion. The term “scuffing” means that something blunt is dragged across the printed image (like brushing fingertips along printed image), or the medium can fold over on itself exposing the image to repeated surface interactions. Scuffing can result in damage to the printed image. Scuffing does not usually remove colorant but it may change the gloss of the area that was scuffed. The term “abrasion” means that force is applied to the printed image generating friction, usually from another object (such as a coin, fingernail, etc.), which can result in wearing, grinding or rubbing away of the printed image. Abrasion is correlated with removal of colorant (i.e., with a loss in optical density (OD)).

By “folding resistance”, it is meant herein that the image printed on the medium is resistant to degradation as a result of being folded and being exposed to weight while in the folded state. The fabric printable medium may be folded when stored and/or shipped. During storage and/or shipping, the folded medium may also be exposed to the weight of another object that is placed on top of the folded medium. The combination of the fold and the weight can cause the printed image to crack or experience colorant removal at or near the fold.

Fire retardance or flame retardance, as used herein, means that the medium is more resistant to catching on fire. The fire retardant layer reduces the flammability of the medium.

Fabric Printable Medium

Examples of the fabric printable medium disclosed herein include a flame retardant ink receiving layer on an image-side of a fabric base substrate, and a waterproof coating on a back-side of the fabric base substrate. The flame retardant ink receiving layer and the waterproof coating contribute to the durability of i) the medium itself and ii) the image(s) printed thereon, and also contributes to the quality of the printed image(s). The formulation of the flame retardant ink receiving layer helps to maintain the soft feel of the fabric base substrate, and the positioning of the flame retardant ink receiving layer on the image-side of fabric base substrate enables the medium to be used in a front lit application.

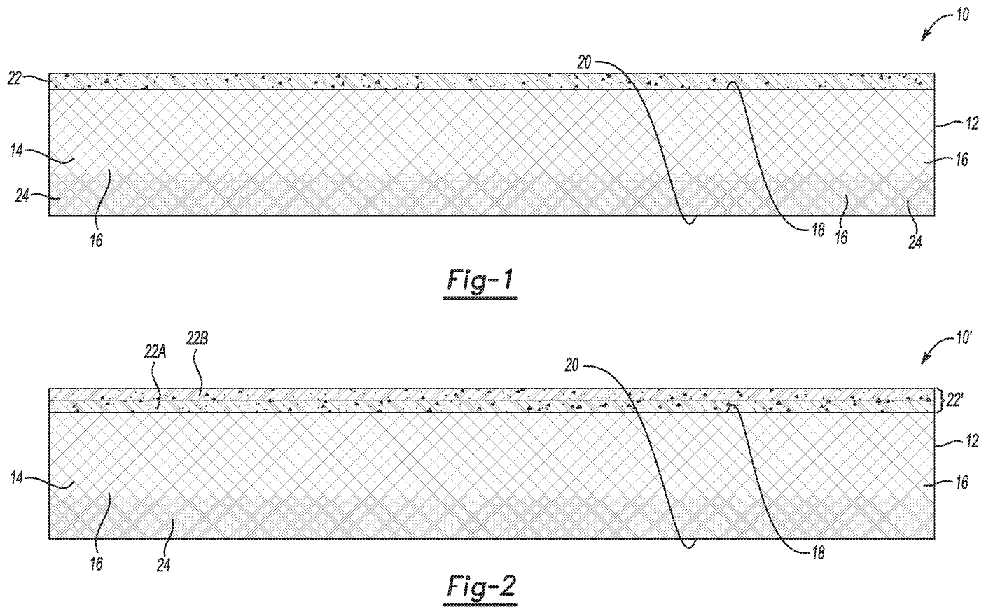

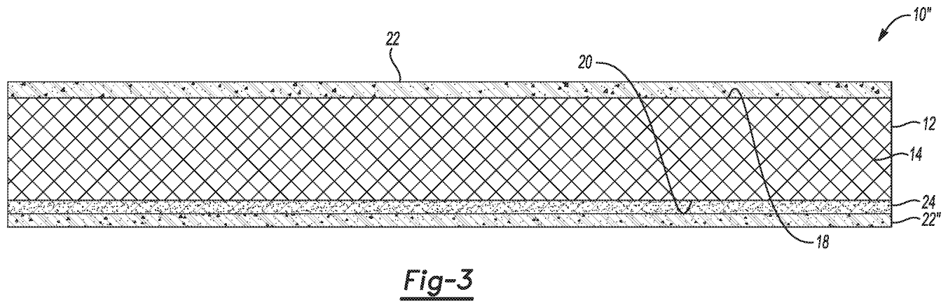

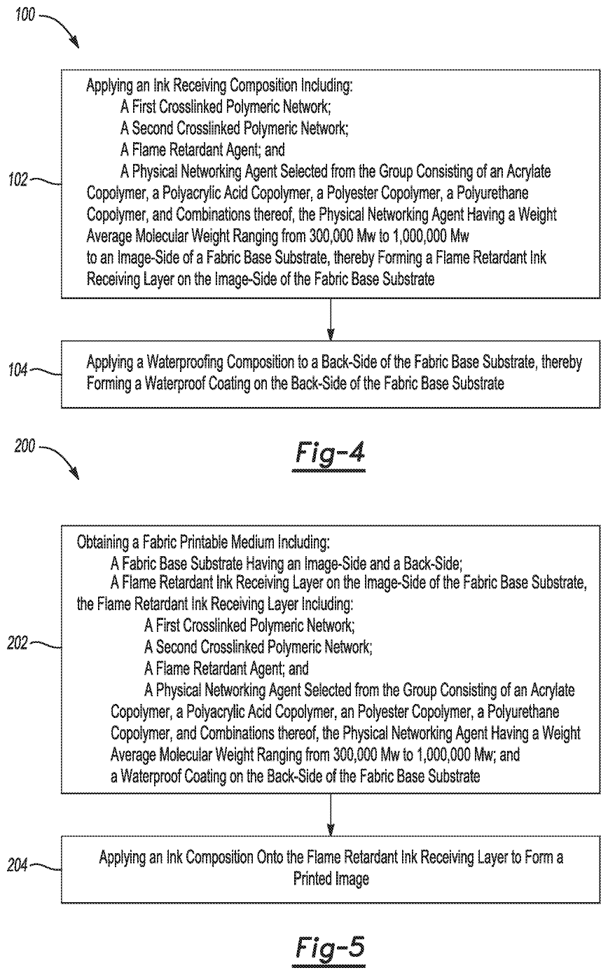

Referring now to FIGS. 1 through 3, examples of the fabric printable medium 10, 10′, 10″ are respectively depicted. One example of the fabric printable medium 10 (as shown in FIG. 1) comprises a fabric base substrate 12 having an image-side 18 and a back-side 20; a flame retardant ink receiving layer 22 on the image-side 18 of the fabric base substrate 12, the flame retardant ink receiving layer 22 including: a first crosslinked polymeric network, a second crosslinked polymeric network, a flame retardant agent, and a physical networking agent selected from the group consisting of an acrylate copolymer, a polyacrylic acid copolymer, a polyester copolymer, a polyurethane copolymer, and combinations thereof, the physical networking agent having a weight average molecular weight ranging from 300,000 Mw to 1,000,000 Mw; and a waterproof coating 24 on the back-side 20 of the fabric base substrate 12. In another example, as shown in FIG. 2, the fabric printable medium 10′ includes the previously listed components of the medium 10, except that the ink receiving layer 22′ includes sub-layers layers 22A and 22B. In still another example, as shown in FIG. 3, the fabric printable medium 10″ includes the previously listed components of the medium 10, and also includes a second flame retardant ink receiving layer 22″ on the waterproof coating 24.

Fabric Base Substrate

Each of the examples of the fabric printable medium 10, 10′, 10″ includes the fabric base substrate 12 upon which the various layer(s) 22, 22′, 22″ and coating 24 are applied. The fabric base substrate 12 is a supporting substrate, in part because it carries the one or more of the layers 22, 22′, 22″ and coating 24 and the image (not shown) that is to be printed.

The fabric base substrate 12 includes yarn strands 14 and voids 16 among the yarn strands 14. As used herein, “yarn” and “yarn strand” refer to a plurality of threads. In an example, the plurality of threads are spun together to form strands. As will be described in more detail below, the strands may have a fabric structure or may be in the form of fibers.

The yarn strands 14 may include natural threads and/or synthetic threads.

Natural threads that may be used include wool, cotton, silk, linen, jute, flax or hemp. Additional threads that may be used include rayon threads or thermoplastic aliphatic polymeric threads derived from renewable resources, such as cornstarch, tapioca products, or sugarcanes. These additional threads can also be referred to as natural threads.

Synthetic threads that may be used include polymeric threads. Examples of polymeric threads include polyvinyl chloride (PVC) threads, or PVC-free threads made of polyester, polyamide, polyimide, polyacrylic, polypropylene, polyethylene, polyurethane, polystyrene, polyaramid (e.g., KEVLAR®), polytetrafluoroethylene (TEFLON®) (both trademarks of E. I. du Pont de Nemours Company), fiberglass, polytrimethylene, polycarbonate, polyethylene terephthalate, or polybutylene terephthalate. It is to be understood that the term “PVC-free” means no polyvinyl chloride (PVC) polymer or vinyl chloride monomer units in the substrate 12. Synthetic threads may also be modified threads from the above-listed polymeric threads. The term “modified threads” refers to polymeric resins that have been made into polymeric threads, where the polymeric threads (one example of the yarn strands 14) and/or the substrate 12 as a whole have undergone a chemical or physical process. Examples of the chemical or physical process include a copolymerization with monomers of other polymers, a chemical grafting reaction to contact a chemical functional group with one or both the polymeric threads and a surface of the substrate 12, a plasma treatment, a solvent treatment (e.g., acid etching), and/or a biological treatment (e.g., an enzyme treatment or antimicrobial treatment to prevent biological degradation).

In some examples, the individual threads of a given yarn strand 14 may be made up of the same type of thread (e.g., natural or synthetic). In other examples, the individual threads of a given yarn strand 14 may be composites or blends of natural and synthetic materials. The natural and synthetic materials may be blended during yarn formation and/or fabric weaving and/or knitting. The weight ratio of natural to synthetic material may vary, and may range anywhere from about 1:99 to about 99:1.

It is to be understood, however, that different yarn strands 14 may be used together in the fabric base substrate 12. In some examples, the yarn strands 14 used in the fabric base substrate 12 include a combination or mixture of two or more from the above-listed natural threads, a combination or mixture of any of the above-listed natural threads with another natural thread or with a synthetic thread, or a combination or mixture of two or more from the above-listed natural threads with another natural thread or with a synthetic thread. In other examples, the yarn strands 14 used in the fabric base substrate 12 includes a combination or mixture of two or more from the above-listed synthetic threads, a combination or mixture of any of the above-listed synthetic threads with another synthetic thread or with a natural thread, or a combination or mixture of two or more from the above-listed synthetic threads with another synthetic thread or with a natural thread. As such, some examples of the fabric base substrate 12 include one yarn 14 containing natural threads and another yarn 14 containing synthetic threads.

When the fabric base substrate 12 includes yarn strands 14 of synthetic threads, the amount of the synthetic yarn strands may range from about 20 wt % to about 90 wt % of the total amount of yarn strands 14. When the fabric base substrate 12 includes yarn strands 14 of natural threads, the amount of the natural yarn strands may range from about 10 wt % to about 80 wt % of the total amount of yarn strands 14. When the fabric base substrate 12 includes yarn strands 14 of synthetic threads and yarn strands 14 of natural threads (e.g., as a woven structure), the amount of the synthetic yarn strands may be about 90 wt % of the total amount of the yarn strands 14 in the fabric base substrate 12, while the amount of the natural yarn strands may be about 10 wt % of the total amount of the yarn strands 14 in the fabric base substrate 12.

The yarn strands 14 may be configured to have a fabric structure. As used herein, the term “fabric structure” is intended to mean a structure having warp and weft that is one of woven, non-woven, knitted, tufted, crocheted, knotted, or pressured, for example. The terms “warp” and “weft” refer to weaving terms that have their ordinary meaning in the textile arts, and as used herein, e.g., warp refers to lengthwise or longitudinal yarns on a loom, while weft refers to crosswise or transverse yarns on a loom.

In an example, the fabric base substrate 12 can be a woven fabric where warp yarns and weft yarns are mutually positioned at an angle of about 90°. This woven fabric may include fabric with a plain weave structure, fabric with twill weave structure where the twill weave produces diagonal lines on a face of the fabric, or a satin weave. In another example, the fabric base substrate 12 can be a knitted fabric with a loop structure including one or both of warp-knit fabric and weft-knit fabric. The weft-knit fabric refers to loops of one row of fabric that are formed from the same yarn strands 14. The warp-knit fabric refers to every loop in the fabric structure that is formed from a separate yarn strands 14, mainly introduced in a longitudinal fabric direction.

In a specific example, the fabric base substrate 12 is woven, knitted, non-woven or tufted and comprises yarn strands 14 selected from the group consisting of wool, cotton, silk, rayon, thermoplastic aliphatic polymers, polyesters, polyamides, polyimides, polypropylene, polyethylene, polystyrene, polytetrafluoroethylene, fiberglass, polycarbonates polytrimethylene terephthalate, polyethylene terephthalate, polybutylene terephthalate, and combinations thereof.

The yarn strands 14 may also be configured as fibers or filaments. In these examples, the fabric base substrate 12 is a non-woven product. The plurality of yarn fibers or filaments may be bonded together and/or interlocked together by a chemical treatment process (e.g., a solvent treatment), a mechanical treatment process (e.g., embossing), a thermal treatment process, a treatment including another substance (such as an adhesive), or a combination of two or more of these processes.

It is to be understood that the configurations of the yarn strands 14 discussed herein include voids 16 among the yarn strands 14. As such, the fiber base substrate 12 is porous. The void 16 encompasses the entire space (extending in the X, Y, and Z directions) between adjacent yarn strands 14. Thus, the shape and dimensions of each void 16 depends upon the yarn strand 14 and its configuration (e.g., woven, non-woven, etc.).

Examples of the fiber base substrate 12 may be subjected to pre-finishing treatment(s), such as desizing, scouring, bleaching, washing, a heat setting process, and/or treatment with various additives. Examples of suitable additives include one or more of colorant (e.g., pigments, dyes, tints), antistatic agents, brightening agents, nucleating agents, antioxidants, UV (ultraviolet light) stabilizers, fillers, and lubricants. As an example, the fabric base substrate 12 may be pre-treated in a solution containing the substances listed above before applying the coating compositions 22, 26. The additives and/or pre-treatments may be included to improve various properties of the fabric base substrate 12. The amount of any given additive included in the fiber base substrate 12 depends upon the additive, but may range from about 0.1 wt % to about 5 wt %.

In some examples, the fabric base substrate 12 has a basis weight that ranges from about 50 gsm to about 400 gsm. In some other examples, the basis weight of the fabric base substrate 12 can range from about 100 gsm to about 300 gsm.

Based on the discussion of the fabric base substrate 12, it is to be understood that the fabric base substrate 12 may be any textile, cloth, fabric material, fabric clothing, or other fabric product or finished article (e.g., blankets, tablecloths, napkins, bedding material, curtains, carpet, shoes, etc.) that includes the yarn strands 14 and the voids 16 among the yarn strands 14. It is to be further understood that the fabric base substrate 12 does not include materials commonly known as paper (even though paper can include multiple types of natural and synthetic fibers or mixture of both types of fibers). Paper may be defined as a felted sheet, roll or other physical form that is made of various plant fibers (like trees or mixture of plant fibers), in some instances with synthetic fibers, which are laid down on a fine screen from a water suspension.

Flame Retardant Ink Receiving Layer

Examples of the flame retardant ink receiving layer 22 (FIGS. 1 and 3), 22A (FIGS. 2), and 22″ (FIG. 3) include the crosslinked polymeric network(s), the flame retardant agent, and the physical networking agent. In these examples, the flame retardant ink receiving layer 22 or 22A may each be a continuous filmed layer that covers the yarn strands 14 and the voids 16 at the image-side 18 of the fabric base substrate 12. As such, in the example shown in FIGS. 1 through 3, the flame retardant ink receiving layer 22 or 22A is directly on a surface of the yarn strands 14 and does not penetrate into a depth of the fabric base substrate 12. It is desirable for the flame retardant ink receiving layer 22 or 22A to remain on the image-side 18 so that the media 10, 10″ exhibit enhanced flame retardance at the image-side 18 and so that the flame retardant ink receiving layer 22 or 22A does not deleteriously affect the flexibility and softness of the fabric base substrate 12. In examples of the medium 10″ shown in FIG. 3, a second flame retardant ink receiving layer 22″ is positioned on the waterproof coating 24. This additional flame retardant ink receiving layer 22″ may be desirable when the medium 10″ is to be used for dual sided printing.

The flame retardant ink receiving layer 22, 22A, 22″ includes the crosslinked polymeric network(s). As used herein, a “polymer network” refers to a polymer and/or a polymer mixture which can be self-crosslinked, by reaction of different functional groups in the same molecular chain, or inter-crosslinked by reaction with another compound which has a different functional group.

In an example, the flame retardant ink receiving layer 22, 22A, 22″ includes a single polymeric network that is individually crosslinked. In this example, the crosslinked polymer network is selected from the group consisting of polyacrylate, polyurethane, vinyl-urethane, acrylic urethane, polyurethane-acrylic, polyether polyurethane, polyester polyurethane, polycaprolactam polyurethane, polyether polyurethane, alkyl epoxy resin, epoxy novolac resin, polyglycidyl resin, polyoxirane resin, polyamine, styrene maleic anhydride, a derivative thereof, or a combination thereof. Any of the specific examples of the crosslinked polymer networks described herein may be used when the crosslinked polymer network is a single polymeric network.

In some other examples, the flame retardant ink receiving layer 22, 22A, 22″ includes two or more polymeric networks. These polymeric networks may be self-crosslinked and/or may be inter-crosslinked. In some of these other examples, the flame retardant ink receiving layer 22, 22A, 22″ includes two separate polymeric networks that are individually crosslinked. In other words, in some examples, the crosslinked polymeric network includes at least a first crosslinked polymeric network that is crosslinked to itself and a second crosslinked polymeric network that is crosslinked to itself. When the first crosslinked polymeric network and the second crosslinked polymeric network are not crosslinked to one another, they can be entangled or appear layered onto one another. In some other of these other examples, the flame retardant ink receiving layer 22, 22A, 22″ includes the two or more polymeric networks that are crosslinked to one another. For example, the first crosslinked polymeric network can be crosslinked to itself and to the second crosslinked polymeric network (which may also be crosslinked to itself).

In some examples, the crosslinked polymer network includes multiple crosslinked polymeric networks, and the crosslinked polymeric networks are different in their chemical structure, although they may be from the same type or class of polymer (e.g., polyurethane, polyester, etc.). In an example, the crosslinked polymeric network includes a first crosslinked polymeric network and a second crosslinked polymeric network, and the first and second crosslinked polymeric networks are different and independently selected from the group consisting of polyacrylate, polyurethane, vinyl-urethane, acrylic urethane, polyurethane-acrylic, polyether polyurethane, polyester polyurethane, polycaprolactam polyurethane, polyether polyurethane, alkyl epoxy resin, epoxy novolac resin, polyglycidyl resin, polyoxirane resin, polyamine, styrene maleic anhydride, derivatives thereof, and combinations thereof.

In some examples of an image-receiving coating composition that is applied to form the flame retardant ink receiving layer 22, 22A, 22″, the crosslinked polymeric network comprises polyacrylate, polyurethane, vinyl-urethane, acrylic urethane, polyurethane-acrylic, polyether polyurethane, polyester polyurethane, polycaprolactam polyurethane, polyether polyurethane, alkyl epoxy resin, epoxy novolac resin, polyglycidyl resin, polyoxirane resin, polyamine, styrene maleic anhydride, a derivative thereof, or a combination thereof. In some other examples, in the image-receiving coating composition, the first crosslinked polymeric network and the second crosslinked polymeric network are different and independently comprises polyacrylate, polyurethane, vinyl-urethane, acrylic urethane, polyurethane-acrylic, polyether polyurethane, polyester polyurethane, polycaprolactam polyurethane, polyether polyurethane, alkyl epoxy resin, epoxy novolac resin, polyglycidyl resin, polyoxirane resin, polyamine, styrene maleic anhydride, a derivative thereof, or a combination thereof.

In one example, any example of the crosslinked polymeric network(s) can include a polyacrylate (i.e., a polyacrylate based polymer). Examples of polyacrylates include polymers made by hydrophobic addition monomers, such as C₁-C₁₂ alkyl acrylates and methacrylates (e.g., methyl acrylate, ethyl acrylate, n-propyl acrylate, isopropyl acrylate, n-butyl acrylate, isobutyl acrylate, sec-butyl acrylate, tert-butyl acrylate, 2-ethylhexyl acrylate, octyl arylate, methyl methacrylate, ethyl methacrylate, n-propyl methacrylate, isopropyl methacrylate, n-butyl methacrylate, isobutyl methacrylate, sec-butyl methacrylate, tert-butyl methacrylate, etc.), aromatic monomers (e.g., phenyl methacrylate, o-tolyl methacrylate, m-tolyl methacrylate, p-tolyl methacrylate, benzyl methacrylate), hydroxyl containing monomers (e.g., hydroxyethylacrylate, hydroxyethylmethacrylate), carboxylic containing monomers (e.g., acrylic acid, methacrylic acid), vinyl ester monomers (e.g., vinyl acetate, vinyl propionate, vinyl benzoate, vinyl pivalate, vinyl-2-ethylhexanoate, vinyl versatate, etc.), vinyl benzene monomer, C₁-C₁₂ alkyl acrylamide and methacrylamide (e.g., t-butyl acrylamide, sec-butyl acrylamide, N,N-dimethylacrylamide, etc.), crosslinking monomers (e.g., divinyl benzene, ethylene glycol dimethacrylate, bis(acryloylamido)methylene, etc.), and combinations thereof. As specific examples, polymers made from the polymerization and/or copolymerization of alkyl acrylate, alkyl methacrylate, and/or vinyl esters may be used. Any of the listed monomers (e.g., hydrophobic addition monomers, aromatic monomers, etc.) may be copolymerized with styrene or a styrene derivative. As specific examples, polymers made from the copolymerization of alkyl acrylate, alkyl methacrylate, and/or vinyl esters, with styrene or styrene derivatives may also be useful.

In one example, the polyacrylate based polymer can include polymers having a glass transition temperature greater than 20° C. In another example, the polyacrylate based polymer can include polymers having a glass transition temperature of greater than 40° C. In yet another example, the polyacrylate based polymer can include polymers having a glass transition temperature of greater than 50° C.

In one example, any example of crosslinked polymeric network(s) can include a polyurethane. The polyurethane may be a self-crosslinked polyurethane polymer, which may be hydrophilic. The self-crosslinked polyurethane polymer can be formed by reacting an isocyanate with a polyol. Example isocyanates used to form the polyurethane polymer can include toluenediisocyanate, 1,6-hexamethylenediisocyanate, diphenylmethanediisocyanate, 1,3-bis(isocyanatemethyl)cyclohexane, 1,4-cyclohexyldiisocyanate, np-phenylenediisocyanate, 2,2,4(2,4,4)-trimethylhexamethylenediisocyanate, 4,4′-dicychlohexylmethanediisocyanate, 3,3′-dimethyldiphenyl, 4,4′-diisocyanate, m-xylenediisocyanate, tetramethylxylenediisocyanate, 1,5-naphthalenediisocyanate, dimethyl-triphenyl-methane-tetra-isocyanate, triphenyl-methane-tri-isocyanate, tris(iso-cyanate-phenyl)thiophosphate, and combinations thereof. Commercially available isocyanates can include RHODOCOAT® WT 2102 (available from Rhodia AG), BASONAT® LR 8878 (available from BASF), DESMODUR® DA, and BAYHYDUR® 3100 (DESMODUR® and BAYHYDUR® are available from Bayer AG). Example polyols used to form the polyurethane polymer can include 1,4-butanediol, 1,3-propanediol, 1,2-ethanediol, 1,2-propanediol, 1,6-hexanediol, 2-methyl-1,3-propanediol, 2,2-dimethyl-1,3-propanediol, neopentyl glycol, cyclo-hexane-dimethanol, 1,2,3-propanetriol, 2-ethyl-2-hydroxymethyl-1,3-propanediol, and combinations thereof.

In some examples, the isocyanate and the polyol can have less than three functional end groups per molecule. In another example, the isocyanate and the polyol can have less than five functional end groups per molecule. In yet another example, the polyurethane can be formed from a polyisocyanate having at least two isocyanate functionalities (—NCO) per molecule and at least one isocyanate reactive group (e.g., such as a polyol having at least two hydroxyl or amine groups). Example polyisocyanates can include diisocyanate monomers and oligomers. The self-crosslinked polyurethane polymer can also be formed by reacting an isocyanate with a polyol, where both isocyanates and polyols have an average of less than three end functional groups per molecule so that the polymeric network is based on a linear polymeric chain structure.

In one example, the polyurethane can be prepared with a NCO/OH ratio ranging from about 1.2 to about 2.2. In another example, the polyurethane can be prepared with a NCO/OH ratio ranging from about 1.4 to about 2.0. In yet another example, the polyurethane can be prepared using an NCO/OH ratio ranging from about 1.6 to about 1.8.

In one example, the weight average molecular weight of the polyurethane polymer used in the first and/or second crosslinked polymeric network can range from about 20,000 Mw to about 200,000 Mw as measured by gel permeation chromatography. In another example, the weight average molecular weight of the polyurethane polymer can range from about 40,000 Mw to about 180,000 Mw as measured by gel permeation chromatography. In yet another example, the weight average molecular weight of the polyurethane polymer can range from about 60,000 Mw to about 140,000 Mw as measured by gel permeation chromatography.

The polyurethane may be aliphatic or aromatic. Some specific examples of commercially available aliphatic waterborne polyurethanes include SANCURE® 1514, SANCURE® 1591, SANCURE® 2260, and SANCURE® 2026 (all of which are available from Lubrizol Inc.). Some specific examples of commercially available caster oil based polyurethanes include ALBERDINGKUSA® CUR 69, ALBERDINGKUSA® CUR 99, and ALBERDINGKUSA® CUR 991 (all from Alberdingk Boley Inc.).

Other examples of the polyurethanes that may make up the polymeric network(s) include vinyl-urethane, acrylic urethane, polyurethane-acrylic, polyether polyurethane, polyester polyurethane, polycaprolactam polyurethane, or polyether polyurethane. Any of these examples may be aliphatic or aromatic. For example, the polyurethane may include aromatic polyether polyurethanes, aliphatic polyether polyurethanes, aromatic polyester polyurethanes, aliphatic polyester polyurethanes, aromatic polycaprolactam polyurethanes, or aliphatic polycaprolactam polyurethanes.

In some examples, any example of the crosslinked polymeric network(s) is formed by using vinyl-urethane hybrid copolymers or acrylic-urethane hybrid copolymers. In yet some other examples, the polymeric network(s) includes an aliphatic polyurethane-acrylic hybrid polymer. Representative commercially available examples of the chemicals which can form an acrylic-urethane polymeric network include NEOPAC®R-9000, R-9699 and R-9030 (from Zeneca Resins) or HYRBIDUR™ 570 (from Air Products and Chemicals). In still another example, the polymeric network includes an acrylic-polyester-polyurethane polymer, such as SANCURE® AU 4010 (from Lubrizol Inc.).

In some examples, any example of the crosslinked polymeric network(s) can include a polyether polyurethane. Representative commercially available examples of the chemicals which can form a polyether-urethane polymeric network include ALBERDINGKUSA® U 205, ALBERDINGKUSA® U 410, and ALBERDINGKUSA® U 400N (all from Alberdingk Boley Inc.), or SANCURE®861, SANCURE® 878, SANCURE® 2310, SANCURE® 2710, SANCURE® 2715, or AVALURE® UR445 (equivalent copolymers of polypropylene glycol, isophorone diisocyanate, and 2,2-dimethylolpropionic acid, having the International Nomenclature Cosmetic Ingredient name “PPG-17/PPG-34/IPDI/DMPA Copolymer” (all from Lubrizol Inc.).

In other examples, any example of the crosslinked polymeric network(s) can include a polyester polyurethane. Representative commercially available examples of the chemicals which can form a polyester-urethane polymeric network include ALBERDINGKUSA® 801, ALBERDINGKUSA® U 910, ALBERDINGKUSA® U 9380, ALBERDINGK®U 2101 and ALBERDINGK®U 420 (all from Alberdingk Boley Inc.), or SANCURE® 815, SANCURE® 825, SANCURE® 835, SANCURE® 843C, SANCURE® 898, SANCURE® 899, SANCURE® 1301, SANCURE® 1511, SANCURE® 2026C, SANCURE® 2255, and SANCURE® 2310 (all from Lubrizol, Inc.).

In still other examples, any example of the crosslinked polymeric network(s) can include a polycarbonate polyurethane. Examples of polycarbonate polyurethanes include ALBERDINGKUSA® U 933 and ALBERDINGKUSA® U 915 (all from Alberdingk Boley Inc.).

Any of the polyurethanes disclosed herein may be crosslinked using a crosslinking agent. In an example, the crosslinking agent can be a blocked polyisocyanate, such as a polyisocyanate blocked using polyalkylene oxide units. In some examples, the blocking units on the blocked polyisocyanate can be removed by heating the blocked polyisocyanate to a temperature at or above the deblocking temperature of the blocked polyisocyanate in order to yield free isocyanate groups. An example of a blocked polyisocyanate can include BAYHYDUR® VP LS 2306 (available from Bayer AG, Germany). In other examples, the polyurethane chain can have a trimethyloxysiloxane group and the crosslinking action can take place by hydrolysis of this functional group to form a silsesquioxane structure. In still other examples, the polyurethane chain can include an acrylic functional group, and the crosslinked structure can be formed by nucleophilic addition to an acrylate group through aceto-acetoxy functionality.

In another example, any example of the crosslinked polymeric network(s) can include an epoxy (i.e., an epoxy functional resin). The epoxy can be an alkyl epoxy resin, an alkyl aromatic epoxy resin, an aromatic epoxy resin, epoxy novolac resins, epoxy resin derivatives, and combinations thereof. In some examples, the epoxy can include at least one, or two, or three, or more pendant epoxy moieties. The epoxy can be aliphatic or aromatic, linear, branched, cyclic or acyclic. If cyclic structures are present, they may be linked to other cyclic structures by single bonds, linking moieties, bridge structures, pyro moieties, and the like.

Examples of commercially available epoxy functional resins can include ANCAREZ®AR555 (from Air Products and Chemicals Inc.), EPI-REZ™ 3510W60, EPI-REZ™ 3515W6, and EPI-REZ™ 3522W60 (all available from Hexion Specialty Chemicals), and combinations thereof.

In some examples, the epoxy functional resin can be an aqueous dispersion of an epoxy resin. Examples of commercially available aqueous dispersions of epoxy resins can include ARALDITE® PZ 3901, ARALDITE® PZ 3921, ARALDITE® PZ 3961-1, ARALDITE® PZ 323 (from Huntsman International LLC), WATERPDXY® 1422 (from BASF), ANCAREZ®AR555 (Air Products and Chemicals, Inc.), and combinations thereof.

In yet other examples, the epoxy resin can include a polyglycidyl and/or a polyoxirane resin. These are examples of self-crosslinked epoxy resins. In these examples, a crosslinking reaction can take place either within the resin itself (through catalytic homopolymerization of the oxirane function group) or with the help of a wide range of co-reactants including polyfunctional amines, acids, acid anhydrides, phenols, alcohols, and/or thiols. The polyglycidyl resin and co-reactants are compatible with each other before curing and in liquid state. The term “compatible” refers here to the fact that there is no significant phase separation after mixing at room temperature.

Examples of the polymeric network(s) including the epoxy may also include an epoxy resin hardener. Some examples of the epoxy resin may be crosslinked by the epoxy resin hardener. Epoxy resin hardeners can be included in solid form, in a water emulsion, and/or in a solvent emulsion. The epoxy resins hardener, in one example, can include liquid aliphatic amine hardeners, cycloaliphatic amine hardeners, amine adducts, amine adducts with alcohols, amine adducts with phenols, amine adducts with alcohols and phenols, amine adducts with emulsifiers, amine adducts with alcohols and emulsifiers, polyamines, polyfunctional polyamines, acids, acid anhydrides, phenols, alcohols, thiols, and combinations thereof. Examples of suitable commercially available epoxy resin hardeners can include ANQUAWHITE®100 (from Air Products and Chemicals Inc.), ARADUR® 3985 (from Huntsman International LLC), EPIKURE™ 8290-Y-60 (from Hexion), and combinations thereof.

In still another example, any example of the crosslinked polymeric network(s) can include a styrene maleic anhydride (SMA). In one example, the SMA can include NOVACOTE® 2000 (Georgia-Pacific Chemicals LLC). In another example, the styrene maleic anhydride can be combined with an amine terminated polyethylene oxide (PEO), an amine terminated polypropylene oxide (PPO), a copolymer thereof, or a combination thereof. The combination of a styrene maleic anhydride with an amine terminated PEO and/or PPO can strengthen the polymeric network by crosslinking the acid carboxylate functionalities of the SMA to the amine moieties on the amine terminated PEO and/or PPO. The amine terminated PEO and/or PPO, in one example, can include amine moieties at one or both ends of the PEO and/or PPO chain, and/or as branched side chains on the PEO and/or PPO. The combination of the styrene maleic anhydride with an amine terminated PEO and/or PPO can provide the flame retardant ink receiving layer 22, 22A, 22″ with the glossy features of the SMA while reducing or eliminating the brittle nature of the SMA. Examples of commercially available amine terminated PEO and/or PPO compounds include JEFFAMINE® XTJ-500, JEFFAMINE® XTJ-502, and JEFFAMINE® XTJ D-2000 (all from Huntsman International LLC). In some examples, a weight ratio of the SMA to the amine terminated PEO and/or PPO can range from about 100:1 to about 2.5:1. In other examples, a weight ratio of the SMA to the amine terminated PEO and/or PPO can range from about 90:1 to about 10:1. In yet other examples, a weight ratio of the SMA to the amine terminated PEO and/or PPO can range from about 75:1 to about 25:1.

In some specific examples including multiple polymeric networks, the first and second polymeric networks of the flame retardant ink receiving layer 22, 22A, 22″ include, respectively, a water based epoxy resin and a water based polyamine. In some other specific examples including multiple polymeric networks, the first and second polymeric networks of the flame retardant ink receiving 22, 22A, 22″ include, respectively, a vinyl urethane hybrid polymer and a water based epoxy resin, and the flame retardant ink receiving layer 22, 22A, 22″ further includes a water based polyamine epoxy resin hardener. In yet other specific examples including multiple polymeric networks, the first and second polymeric networks of the flame retardant ink receiving layer 22, 22A, 22″ include, respectively, an acrylic-urethane hybrid polymer and a water based epoxy resin, and the flame retardant ink receiving layer 22, 22A, 22″ further includes a water based polyamine epoxy resin hardener. In still further specific examples including multiple polymeric networks, the first and second polymeric networks of the flame retardant ink receiving layer 22, 22A, 22″ include, respectively, a polyurethane and an epoxy resin. In yet a further example including multiple polymeric networks, the first and second polymeric networks of the flame retardant ink receiving layer 22, 22A, 22″ include, respectively, polyoxyethlene glycol sorbitan alkyl esters and polyoxyethlene glycol octylphenol ethers.

When the flame retardant ink receiving layer 22, 22A, 22″ includes a single crosslinked polymeric network, the crosslinked polymeric network can represent from about 80 wt % to about 99 wt % of the total weight of the flame retardant ink receiving layer 22, 22A, 22″. When the flame retardant ink receiving layer 22, 22A, 22″ includes multiple polymeric networks, the flame retardant ink receiving layer 22, 22A, 22″ may include the first and second crosslinked polymeric networks in a variety of amounts. In an example including the first and second polymeric networks, the first and second crosslinked polymeric networks can collectively represent from about 15 wt % to about 75 wt % of the total weight of the flame retardant ink receiving layer 22, 22A, 22″. In another example including the first and second polymeric networks, the first and second crosslinked polymeric networks can collectively represent from about 20 wt % to about 55 wt % of the total weight of the flame retardant ink receiving layer 22, 22A, 22″. In a further example including the first and second polymeric networks, the first and second crosslinked polymeric networks can collectively range from about 25 wt % to about 40 wt % of the total weight of the flame retardant ink receiving layer 22, 22A, 22″. In some examples including the first and second polymeric networks, the first and second crosslinked polymeric networks can be present in equal amounts. In other examples including the first and second polymeric networks, the first and second crosslinked polymeric networks can be present in different amounts.

While the first and second crosslinked polymer networks have been described, it is to be understood that in some examples, the flame retardant ink receiving layer 22, 22A, 22″ can include one or more additional crosslinked polymer networks. Any of the previously described crosslinked polymer networks may be used as the additional network(s).

The flame retardant ink receiving layer 22, 22A, 22″ also includes the flame retardant agent. The flame retardant agent is included to provide the fabric printable medium 10, 10′, 10″ with fire or flame retardance. The flame retardant agent may be a liquid or a solid at room temperature (e.g., from about 18° C. to about 22° C.). When in solid form, the flame retardant agent may also function as a filler in the flame retardant ink receiving layer 22, 22A, 22″.

In an example, the flame retardant agent is selected from the group consisting of a mineral compound, a phosphorus-containing compound, a nitrogen-containing compound, a polymeric brominated compound, an organohalogenated compound, an organophosphate compound, alumina trihydrate, and combinations thereof.

Examples of the mineral compound include aluminum hydroxide, magnesium hydroxide, huntite (magnesium calcium carbonate), hydromangesite (hydrated magnesium carbonate), phosphorus, red phosphorus, boehmite (aluminum oxide hydroxide), boron compounds, or combinations thereof.

Examples of the phosphorus-containing compound can include phosphates, phosphonates, phosphinates, and combinations thereof. In some examples, the phosphorus-containing compound can have different oxidations states. In one example, the phosphorus-containing compound can be a closed ring structure such as FR-102® (available from Shanghai Xusen Non-Halogen Smoke Suppressing Fire Retardants Co. Ltd, China) and AFLAMMIT® (available from Thor). In another example, the phosphorus-containing compound can be a water-soluble phosphorus-containing compound. Examples of water-soluble phosphorus-containing compounds can include a phosphonate ester with one or two, closed 4 to 6 member phosphorus containing ring structures. In one example, the water-soluble phosphorus-containing compound is 5-ethyl-2-methyl-1,3,2,-dioxaphosphoranian-5-yl)methyl dimethyl phosphonate P oxide. In another example, the water-soluble phosphorus-containing compound is bis[(-ethyl-2-methyl-1,3,2-dioxaphosphorinan-5-yl)methyl] methyl phosphonate P,P′-dioxide.

In some examples, the phosphorus-containing compound is a composition including a metal and phosphorus, or a composition including a halogen and phosphorus. Example metal and phosphorus containing compositions can include aluminum diethylphosphinate, calcium diethylphosphinate, and combinations thereof. Example halogen and phosphorus containing compositions can include tris(2,3-dibromopropyl) phosphate, chlorinated organophosphates, tris(1,3-dichloro-2-propyl) phosphate, tetrekis(2-chloroethyl) dicloro-isopentyldiphosphate, tris (1,3-dichloroisopropyl) phosphate, tris(2-chloroisopropyl) phosphate, and combinations thereof.

Examples of nitrogen-containing compounds can include melamine, melamine derivatives, melamine cyanurate, melamine polyphosphate, melem (heptazine derivative), melon (heptazine derivative), and combinations thereof.

The polymeric brominated compound can include brominated polystyrenes, brominated carbonate oligomers, brominated epoxy oligomers, tetrabromophthalic anhydride, tetrabromo-bisphenol A, hexabromocyclododecane, and combinations thereof.

Examples of suitable organohalogenated compounds include organobromines (see the previously listed polymeric brominated compounds), organochlorines, decabromodiphenyl ether, decabromodiphenyl ethane, and combinations thereof. Some examples of organochlorines include chlorendic acid, ethers of chlorendic acid, and chlorinated paraffins.

The organophosphate can include aliphatic phosphate, aliphatic phosphonate, aromatic phosphonate, aliphatic organophosphate, aromatic organophosphate, polymeric organophosphate with 2 or 3 oxygen atoms attached to the central phosphorus, and combinations thereof.

Examples of some commercially available flame retardant agents include FR102® (available from Shanghai Xusen Co Ltd) or AFLAMMIT® PE and AFLAMMIT® MSG (both available from Thor), EXOLIT®AP compounds (available from Clariant), solid AFLAMMIT® powder compounds (available from Thor), DISFLAMOLL®DPK (available from Lanxess), or PHOSLITE® B compounds (available from Italmatch Chemicals).

When in solid form, the flame retardant agent may be in the form of fine particles. As an example, the average particle size of the flame retardant agent ranges from about 0.1 μm to about 20 μm.

Any of the flame retardant agents disclosed herein may be used alone, in any combination with each other, or in combination with another flame retardant. In some examples, the flame retardant agent includes a combination of the phosphorus-containing compound, the nitrogen-containing compound and/or the halogen. In other examples, the flame retardant agent includes a combination of the phosphorus-containing compound and the nitrogen-containing compound. A specific combination includes ammonium polyphosphate (APP), poly 4,4-diam inodiphenyl methane spirocyclic pentaerythritol bisphosphonate (PDSPB), and 1,4-di(diethoxy thiophosphamide benzene (DTPAB).

When combinations of two flame retardant agents are utilized, the weight ratio of the first flame retardant agent to the second flame retardant agent may range from about 1:99 to about 99:1. In other examples, the weight ratio of two different flame retardant agents may range from about 1:20 to about 20:1. In certain specific examples, the weight ratio can range from about 2:1 to about 35:1.

The flame retardant agent can be present, in the flame retardant ink receiving layer 22, 22A, 22″, in an amount ranging from about 25 wt % to about 85 wt % of a total weight of the flame retardant ink receiving layer 22, 22A, 22″. In other examples, the flame retardant agent can make up from about 30 wt % to about 80 wt %, or from about 35 wt % to about 75 wt % of the total weight of the flame retardant ink receiving layer 22, 22A, 22″.

Whether a solid or liquid flame retardant agent is used, it may be used in combination with a filler. In some examples, a filler package of the flame retardant ink receiving layer 22, 22A, 22″ may include the solid flame retardant agent and another filler (which may have little or no flame retardant properties). In other examples, the filler package of the flame retardant ink receiving layer 22, 22A, 22″ may include the filler (which may have little or no flame retardant properties), and the flame retardant agent may be a liquid that does not function as a filler.

The (additional) filler may be a non-flame retardant filler or a filler exhibiting minimal flame retardance. As examples, the filler is selected from the group consisting of ground calcium carbonate, precipitated calcium carbonate, titanium dioxide, kaolin clay, calcined clay, silicates, alumina, and combinations thereof. In another example, the filler is selected from the group consisting of ground calcium carbonate, precipitated calcium carbonate titanium dioxide, clay, silica, alumina, and combinations thereof.

In some examples, the flame retardant ink receiving layer 22, 22A, 22″ further includes the filler, and a dry weight ratio of the filler to the flame retardant agent ranges from about 2:1 to about 35:1. In other examples, the dry weight ratio of the filler to the flame retardant agent may range from about 3:1 to about 20:1, or from about 5:1 to about 15:1.

When the filler and the flame retardant are present together in the flame retardant ink receiving layer 22, 22A, 22″, the filler and the flame retardant collectively represent from about 25 wt % to about 90 wt % of a total weight of the flame retardant ink receiving layer 22, 22A, 22″. In other examples, the filler and the flame retardant collectively make up from about 35 wt % to about 80 wt %, or from about 30 wt % to about 75 wt % of the total weight of the flame retardant ink receiving layer 22, 22A, 22″.

In the examples disclosed herein, the flame retardant ink receiving layer 22, 22A, 22″ further includes a physical networking agent. In the example media 10, 10′, 10″ shown in FIGS. 1 through 3, it may be desirable to include the physical networking agent to help retain the flame retardant ink receiving layer 22, 22A on the image-side 18 (without substantial penetration into the fabric base substrate 12). The minimal or lack of penetration of the flame retardant ink receiving layer 22, 22A into the fabric base substrate 12 can help to maintain the soft feel of the fabric base substrate 12. In the example medium 10″ shown in FIG. 3, it may be desirable to include the physical networking agent to help retain the second flame retardant ink receiving layer 22″ adjacent to the back-side 18 (without substantial penetration into waterproof coating 24).

The physical networking agent can be a chemical that promotes physical bonding with polymeric networks and/or the flame retardant agent to form a gel-like solution or a physical network. When the ink receiving composition used to form the flame retardant ink receiving layer 22, 22A, 22″ is a “gel-like solution”, it is meant that the composition can have a low solids content (i.e., from about 5 wt % to about 30 wt %) and a high viscosity (>15,000 cps) at low shear stress (at 6 rpm) when measured by a Brookfield viscometer (Brookfield AMETEK, Massachusetts) at 25° C. In another example, the high viscosity is 20,000 cps at 6 rpm, and in still another example, the high viscosity is 30,000 cps at 6 rpm. A gel-like solution can behave like a non-flowable, semi solid gel, but is able to de-bond at higher shear forces, e.g., 100 rpms or greater, to yield a low viscosity fluid, e.g., less than 500 cps.

As such, examples of the ink receiving composition can have thixotropic behavior. As used herein, “thixotropic behavior” refers to fluids that are non-Newtonian fluids, i.e. which can show a shear stress-dependent change in viscosity. The term “non-Newtonian” refers herein to fluid having a viscosity change that is a non-linear response to a shear rate change. For example, a fluid may exhibit non-linear shear thinning behavior in viscosity with an increasing rate of shear. The stronger the thixotropic characteristic of the ink receiving composition when it undergoes shear stress, the lower the viscosity of the ink receiving composition. When the shear stress is removed or reduced, the viscosity can be increased again. Without being limited to any theory, it is believed that such thixotropic behavior reduces the penetration of the ink receiving composition into the fabric base substrate 12 and helps retain the composition at the image-side 18 surface of the substrate 12, or reduces the penetration of the ink receiving composition into the waterproof coating 24. The ink receiving composition becomes thin under shear force when applied by a coating application head (such under the knife with a floating knife coater). When the ink receiving composition is deposited (the nip of the blade and shear force are removed), the viscosity of fluid can be quickly increased and the flame retardant ink receiving layer 22, 22A can remain on a surface at the image-side 18 of the fabric base substrate 12 or the second flame retardant ink receiving layer 22″ can remain on a surface of the waterproof coating 24.

The physical networking agent is a high molecular weight polymer, i.e. having a weight average molecular weight ranging from about 300,000 to about 1,000,000. The physical networking agent can be copolymers of acrylates, copolymers with an acrylate based polyelectrolyte backbone, copolymers with a polyester backbone, or copolymers with a polyurethane backbone. Another suitable physical networking agent is hydroxyethyl cellulose. In some examples, the physical networking agent is selected from the group consisting of copolymers of acrylates, copolymers with an acrylate based polyelectrolyte backbone, copolymers with a polyester backbone, and copolymers with a polyurethane backbone.

In some other examples, the physical networking agent is a copolymer of acrylates, such as a copolymer of methacrylic acid and ethyl acrylate ester; a copolymer having with an acrylate based polyelectrolyte backbone and a weight average molecular weight ranging from about 300,000 Mw to about 1,000,000 Mw; a copolymer having a polyester backbone and a weight average molecular weight ranging from about 300,000 Mw to about 1,000,000 Mw; a copolymer having a polyurethane backbone and a weight average molecular weight ranging from about 300,000 Mw to about 1,000,000 Mw; or a combination thereof. In yet some other examples, the physical networking agent can include an acrylate copolymer, a polyethylene glycol copolymer, a polyurethane copolymer, an isophorone diisocyanate copoylmer, or a combination thereof and the physical networking agent can have a weight average molecular weight ranging from 300,000 Mw to 1,000,000 Mw.

In some specific examples, the physical networking agent is a high molecular weight copolymer of acrylates (i.e., having a weight average molecular weight ranging from about 300,000 to about 1,000,000) such as a copolymer of methacrylic acid and ethyl acrylate ester. Examples of such compounds include ACUSOL® 810A, ACUSOL® L830, ACUSOL® 835, and ACUSOL® 842 (from Rohm Haas/Dow Co); or ALCOGUM® L11, ALCOGUM® L12, ALCOGUM® L51, ALCOGUM® L31, and ALCOGUM® L52 (from Akzo Nobel Co); or STEROCOLL® FS (from BASF). In some examples, the physical networking agent is an aqueous anionic dispersion of an ethyl acrylate-carboxylic acid copolymer such as STEROCOLL® FS (from BASF).

In some other specific examples, the physical networking agent is a high molecular weight copolymer with an acrylate based polyelectrolyte backbone. Such high molecular weight copolymers with an acrylate based polyelectrolyte backbone can be, for example, acrylate acid copolymers that include, in the backbone and distributed throughout the polymer chain, grafted pendant groups with long-chain hydrophobic groups and acid groups. Examples of such polymers that are commercially available include TEXICRYL® 13-317, TEXICRYL® 13-313, TEXICRYL® 13-308, and TEXICRYL® 13-312 (all from Scott Bader Group).

In yet some other specific examples, the physical networking agent is a high molecular weight copolymer with a polyester backbone. Such high molecular weight copolymers with a polyester backbone can be, for example, polyethylene glycol copolymers that include, in the backbone and distributed throughout the polymer chain, grafted pendant with long-chain hydrophobic groups and polar groups. Examples of such polymers that are commercially available include RHEOVIS® PE from BASF.

In still further specific examples, the physical networking agent is a high molecular weight copolymer with a polyurethane backbone. Such high molecular weight copolymers with a polyurethane backbone can be, for example, copolymers of polyethylene glycol and isophorone diisocyanate, which can have long-chain alkanols at the end-caps and also backbone distributed throughout the polymer chain. Examples of such polymers that are commercially available include ACUSOL® 880 and ACUSOL® 882 (from Rohm Haas).

Still another example of a suitable physical networking agent is hydroxyethyl cellulose. An example that is commercially available is TYLOSE® HS30000 (from SE Tylose GmbH & Co. KG).

The flame retardant ink receiving layer 22, 22A, 22″ may include the physical networking agent in a variety of amounts. The physical networking agent may range from about 0.5 wt % to about 10 wt % of the total weight of the flame retardant ink receiving layer 22, 22A, 22″.

The flame retardant ink receiving layer 22, 22A, 22″ may also include a synergist, which enhances the efficiency of the flame retardant agent. Examples of suitable synergists include antimony trioxide, antimonite, and antimony pentoxide. The weight ratio between flame retardant agent and the synergist compound can range from about 1:1 to about 4:1.

The ink receiving composition used to form the flame retardant ink receiving layer 22, 22A, 22″ may include, in addition to the polymeric networks, flame retardant agent, physical networking agent, and water, processing aids, such as rheology control agent(s), surfactant(s) (e.g., BYK-DYNWET 800 N from BYK), pH adjuster(s), defoamer(s), optical property modifier(s) (e.g., dye), or combinations thereof. Any of these aids that are not removed during drying remain in the flame retardant ink receiving layer 22, 22A, 22″. It is to be understood that any of the chemical components in the flame retardant ink receiving layer 22, 22A, 22″, and the ink receiving composition used to form the flame retardant ink receiving layer 22, 22A, 22″, are compatible. The amount of any given additive included in the flame retardant ink receiving layer 22, 22A, 22″ depends upon the additive, but may be less than 10 wt % of the total weight of the layer 22, 22A, 22″, or may range from about 0.1 wt % to about 5 wt % of the total weight of the flame retardant ink receiving layer 22, 22A, 22″.

The flame retardant ink receiving layer 22, 22A, 22″ may have a dry coat-weight ranging from about 1 gsm to about 10 gsm. In other examples, the flame retardant ink receiving layer 22, 22A, 22″ may have dry coat-weight ranging from about 2 gsm to about 5 gsm.

Referring now specifically to FIG. 2, the ink receiving layer 22′ includes sub-layers 22A (previously described herein) and 22B. In this example layer 22′, the flame retardant ink receiving layer 22A is an interior layer that is positioned directly on the image-side 18 of the fabric base substrate 12, and an outermost ink receiving layer 22B is positioned on the flame retardant ink receiving layer 22A. The outermost ink receiving layer 22B may or may not have flame retardant properties, and may be included to enhance the optical properties of the medium 10′. As such, some examples of the medium 10′ include the components of the medium 10, and further include outermost ink receiving layer 22B on the flame retardant ink receiving layer 22A, the outermost ink receiving layer 22B including the first crosslinked polymeric network, the second crosslinked polymeric network, the physical networking agent, and a filler selected from the group consisting of calcium carbonate (e.g., precipitated or ground), titanium dioxide, clay (kaolin, calcined, etc.), alumina, silica and combinations thereof. Any of the first crosslinked polymeric networks, the second crosslinked polymeric networks, and the physical networking agents may be used in any of the amounts disclosed herein in the outermost ink receiving layer 22B. The filler may be included in the outermost ink receiving layer 22B in an amount ranging from about 5 wt % to about 90 wt % of a total weight of the outermost ink receiving layer 22B. In these examples of the medium 10′, the flame retardant ink receiving layer 22A may or may not include the filler and the outermost ink receiving layer 22B may or may not include the flame retardant agent.

It is to be understood that the ink receiving composition used to form the outermost ink receiving layer 22B may also include, in addition to the polymeric networks, physical networking agent, filler, and water, processing aids, such as rheology control agent(s), surfactant(s) (e.g., BYK-DYNWET 800 N from BYK), pH adjuster(s), defoamer(s), optical property modifier(s) (e.g., dye), or combinations thereof.

The outermost ink receiving layer 22B may have a dry coat-weight ranging from about 1 gsm to about 10 gsm.

Waterproof Coating

As shown in FIGS. 1 through 3, the examples of the fabric printable medium 10, 10′, 10″ also include a waterproof coating 24 on the back-side 20 of the fabric base substrate 12. In the example medium 10″ shown in FIG. 2, the waterproof coating 24 is positioned in between the fabric base substrate 12 and the second flame retardant ink receiving layer 22″. As shown in FIGS. 1 and 2, the waterproof coating 24 may coat the yarn strands 14 and thus may be a non-continuous, porous coating. In this example, at least some of the voids 16 at the back-side 20 remain open (i.e., the waterproof coating 24 does not block at least some of the voids 16). As such, in some examples, the fabric base substrate 12 includes yarn strands 14 and voids among the yarn strands, and the waterproof coating 24 is attached to the yarn strands 14 of the fabric base substrate 12 such that at least some of the voids 16 remain open. To maintain at least some open voids 16, the waterproof composition may be applied at a lower coat-weight (e.g., 2 gsm or less). In other examples, as shown in FIG. 3, the waterproof coating 24 may be a continuous film that covers the yarn strands 14 and the voids 16 at the back-side 20 of the fabric base substrate 12. It may be desirable (in some instances) for the waterproof coating 24 to remain on the back-side 20 so that the waterproof coating 24 does not interfere with the ink receiving function of the flame retardant ink receiving layers 22 or the ink receiving sub-layers 22A and 22B, or deleteriously affect the flexibility and softness of the fabric base substrate 12.

The waterproof coating 24 provides the fabric base substrate 12 with a low enough surface energy to generate a waterproof function. In an example, the waterproof coating 24 has a surface energy of less than 50 mJ/m². In another example, the surface energy of the waterproof coating 24 ranges from about 34 mJ/m² to about 47 mJ/m². The surface energy contributes to the waterproof function, which keeps the fabric printable medium 10, 10′, 10″ from absorbing water, e.g., when exposed to outdoor conditions, such as rain or snow. As such, the waterproof coating 24 improves the weather resistance of the fabric printable medium 10, 10′, 10″.

The waterproof coating 24 includes a physical networking agent to help obtain the desirable coating properties (i.e., to coat the yarn strands 14 so that voids 16 remain open, or to retain the waterproof coating 24 on the back-side 20 without substantial penetration into the fabric base substrate 12) and also includes a waterproof agent to obtain the desired surface energy on the back-side 20.

Any of the physical networking agents previously described may be used in the waterproof coating 24. In the waterproof coating 24, the physical networking agent can promote physical bonding with the waterproof agent to form a gel-like solution, which exhibits thixotropic behavior. Without being limited to any theory, it is believed that such thixotropic behavior reduces the penetration of the waterproofing composition into the fabric base substrate 12 and helps retain the composition at the back-side 20 surface of the substrate 12. The waterproofing composition becomes thin under shear force when applied by a coating application head (such as under the knife with a floating knife coater). When the waterproofing composition is deposited (the nip of the blade and shear force are removed), the viscosity of fluid can be quickly increased and, depending on the amount applied, the waterproof coating 24 can either remain on the yarn strand surfaces (leaving open voids 16), or remain on the surface at the back-side 20 of the fabric base substrate 12 (i.e., covering the voids 16).

Examples of the waterproof agent in the waterproof coating 24 include polyvinylidene chloride (PVC), a polyolefin, poly(ethylene terephthalate), a wax, perfluorooctane sulfonate, perfluorooctanoic acid, a hydrogen siloxane, a long chain hydrocarbon, and a modified fatty resin. Examples of the polyolefin include polyethylene, polypropylene, or combinations thereof. Examples of the long chain hydrocarbons include at least 100 repeating units. Commercially available examples of the long chain hydrocarbon include BAYGARD® WRC (from Tanatex Chemicals) and ECOREPEL® (from Schoeller). Commercially available examples of the modified fatty resins include PHOBOTEX® RHP, PHOBOTEX® RSH, and PHOBOTEX® RHW (from Huntsman International LLC). Microencapsulated waterproofing chemicals, such as SMARTREPEL® Hydro (from Archroma) may also be used. In still another example, a fluorinated acrylic copolymer, such as PHOBOL® CP-C from Hunstman International LLC, may be used.

In some specific examples, the waterproof coating 24 includes a physical networking agent selected from the group consisting of an acrylate copolymer, a polyacrylic acid copolymer, a polyester copolymer, a polyurethane copolymer, and combinations thereof, the physical networking agent having a weight average molecular weight ranging from 300,000 Mw to 1,000,000 Mw; and a waterproof agent selected from the group consisting of polyvinylidene chloride, a polyolefin, poly(ethylene terephthalate), a wax, perfluorooctane sulfonate, perfluorooctanoic acid, a hydrogen siloxane, a long chain hydrocarbon, and a modified fatty resin.

Other functional additives may be included in the waterproof coating 24. Functional additives can be added to control a specific property. Some examples include surfactant(s) for wettability, defoamer(s) for processing control, base or acid buffer(s) for pH control.

Depending on the thixotropic behavior of the waterproof composition and the chemical environment of the waterproof composition (e.g., such as the pH), the weight ratio of water:waterproof agent:physical networking agent:additives may be 100:2:0.8:0.2, and in another example, the ratio may be 100:2:0.55:0.2.

The waterproof coating 24 may have dry coat-weight ranging from about 0.01 gsm to about 5 gsm, or from about 1 to about 3 gsm, or from about 0.05 gsm to about 0.5 gsm.

Method for Forming the Fabric Printable Medium

An example of the method 100 for forming the fabric printable medium 10 is depicted in FIG. 3. As shown in FIG. 3, the method 100 includes applying an ink receiving composition including a first crosslinked polymeric network, a second crosslinked polymeric network, a flame retardant agent, and a physical networking agent selected from the group consisting of an acrylate copolymer, a polyacrylic acid copolymer, a polyester copolymer, a polyurethane copolymer, and combinations thereof, the physical networking agent having a weight average molecular weight ranging from 300,000 Mw to 1,000,000 Mw to an image-side 18 of a fabric base substrate 12, thereby forming a flame retardant ink receiving layer 22 or 22A on the image-side 18 of the fabric base substrate 12 (reference numeral 102); and applying waterproofing composition to a back-side 20 of the fabric base substrate 12, thereby forming a waterproof coating 24 on the back-side 20 of the fabric base substrate 12 (as shown at reference numeral 104).

Prior to coating the fabric base substrate 12, it is to be understood that the fabric base substrate 12 may be exposed to pre-treatment processes, such as scouring, heat setting, whitening, etc.

The ink receiving composition used to form the flame retardant ink receiving layer 22, 22A, 22′ is an aqueous dispersion of the first and second crosslinked polymeric networks, the flame retardant agent, and the physical networking agent described herein. In some examples, this ink receiving composition further includes the filler (e.g., calcium carbonate, titanium dioxide, etc.). The flame retardant agent may be a dry powder that is added to the aqueous dispersion, or may be pre-dispersed to make a dispersion that is added to the aqueous dispersion, or may be a slurry that is added to the aqueous dispersion, or may be an aqueous suspension that is added to the aqueous dispersion. In some examples, the first and second crosslinked polymeric networks, the flame retardant agent, and the physical networking agent can collectively represent from about 80% to about 99% of the total solids of the ink receiving composition. In other examples, the first and second crosslinked polymeric networks, the flame retardant agent, the filler and the physical networking agent can collectively represent from about 80% to about 99% of the total solids of the ink receiving composition. In either of these examples, the aqueous dispersion has a solids content of 55% or less. In an example, the aqueous dispersion has a solids content of at least 10 wt %.

To apply the ink receiving composition to form the layers 22 or 22A, any suitable coating technique may be used that will form a thin continuous coating on the image-side 18 of the fabric base substrate 12. As mentioned above, the ink receiving composition is a gel-like solution that becomes thin under shear force when applied by a coating application head (such as under the knife with a floating knife coater). In these instances, when the ink receiving composition is deposited (and the nip of the blade and shear force are removed), the viscosity of fluid can be quickly increased and the ink receiving layer 22, 22A can remain on surface at the image-side 18 of the fabric base substrate 12. As such, an example of the method 100 includes applying a shear force to reduce a viscosity of ink receiving composition as the ink receiving composition is being deposited on the image-side 18; removing the shear force to increase the viscosity of the ink receiving composition, whereby the ink receiving composition remains at a surface of the image-side 18 of the fabric base substrate 12; and calendering the applied ink receiving composition. The method may or may not include the calendering of the applied ink receiving composition. A similar technique may be used to form the second flame retardant ink receiving layer 22″ on the waterproof coating 24.

Suitable coating techniques involving the application and subsequent removal of shear force include a floating knife process or a knife on roll mechanism process. The floating knife process can include stretching the fabric base substrate 12 to form an even uniform surface. The floating knife process can further include transporting the fabric base substrate 12 under a stationary knife blade. The knife-on-the roll mechanism (used to apply the composition) can be followed by passing the substrate 12 and composition through calendaring pressure nips. The calendaring can be done either in room temperature or at an elevated temperature and/or pressure. The elevated temperature can range from about 40° C. to about 100° C., and the elevated pressure can range from about 500 PSI to about 3,000 PSI.

To form the fabric printable medium 10′ shown in FIG. 2, the method 100 may further include applying another ink receiving composition, which includes a first crosslinked polymeric network, a second crosslinked polymeric network, a physical networking agent, and a filler selected from the group consisting of calcium carbonate, titanium dioxide, and combinations thereof, on the flame retardant ink receiving layer 22A. In an example of the method 100, the other ink receiving composition may be applied after the ink receiving coating 22, 22A is applied.

In any examples of the method 100, the waterproof coating 24 is applied before or after the ink receiving layer 22 is, or 22A and 22B are applied. As such, in some examples, the waterproofing composition is applied after the ink receiving composition is applied. This may minimize any adhesion impact to the ink receiving layer 22 or 22A and 22B.

The waterproofing composition includes the physical networking agent and the waterproofing agent. In the composition, the waterproofing agent may be in the form of an emulsion. As such, in an example, the waterproofing composition includes a physical networking agent selected from the group consisting of an acrylate copolymer, a polyacrylic acid copolymer, a polyester copolymer, a polyurethane copolymer, and combinations thereof, the physical networking agent having a weight average molecular weight ranging from 300,000 Mw to 1,000,000 Mw; and a waterproof agent selected from the group consisting of polyvinylidene chloride emulsion, a polyolefin emulsion, a poly(ethylene terephthalate) emulsion, an aqueous wax emulsion, a perfluorooctane sulfonate emulsion, a perfluorooctanoic acid emulsion, a hydrogen siloxane emulsion, a long chain hydrocarbon emulsion, and a modified fatty resin emulsion.

Any of the previously described coating techniques may be used to apply the waterproofing composition to form the waterproof coating 24. In another example, the treatment process is achieved by floating knife, where the fabric base substrate 12 is stretched flat to form an even uniform surface and is transported under a stationary doctor blade. In still another example, the treatment process is achieved by rod coating where a rod (such as Mayer rod) is used to control the amount of the treatment compound. Further, in another example, the treatment process is achieved by air knife coating where pressure air is induced to control the amount of the waterproofing composition.

As mentioned above, the waterproofing composition is gel-like solution that becomes thin under shear force when applied by a coating application head (such as under the knife with a floating knife coater). When the waterproofing composition is deposited (and the nip of the blade and shear force are removed), the viscosity of fluid can be quickly increased and the waterproof coating 26 can either coat the yarn strands 14 (leaving voids 16 open) (e.g., when the amount applied is relatively low, e.g., at a coat-weight of 2 gsm or less) or remain on surface at the back-side 20 of the fabric base substrate 12 (e.g., when the amount applied is higher, e.g., at a coat-weight of more than 2 gsm).

The applied waterproofing composition may then be exposed to drying to form the waterproof coating 24.

To form the fabric printable medium 10″ shown in FIG. 3, the method 100 may further include applying the same ink receiving composition used to form the layer 22 or 22A, on the waterproof coating 24.

Printing Method

An example of the printing method 200 is depicted in FIG. 4. As shown in FIG. 4, the method 200 includes obtaining a fabric printable medium 10 including: a fabric base substrate 12 having an image-side 18 and a back-side 20; a flame retardant ink receiving layer 22 in the image-side 18 of the fabric base substrate 12, the flame retardant ink receiving layer 22 including a first crosslinked polymeric network, a second crosslinked polymeric network, a flame retardant agent, and a physical networking agent selected from the group consisting of an acrylate copolymer, a polyacrylic acid copolymer, a polyester copolymer, a polyurethane copolymer, and combinations thereof, the physical networking agent having a weight average molecular weight ranging from 300,000 Mw to 1,000,000 Mw; and a waterproof coating 24 on the back-side 20 of the fabric base substrate 12 (as shown at reference numeral 202); and applying an ink composition onto the flame retardant ink receiving layer 22, 22′ to form a printed image (as shown at reference numeral 204). In some examples, the ink composition is also applied onto the second flame retardant ink receiving layer 22″ to form a printed image.

Any example of the fabric printable medium 10, 10′, 10″ disclosed herein may be used in the method 200. The ink is printed onto flame retardant ink receiving layer(s) 22, 22′, 22″. The flame retardant ink receiving layer(s) 22, 22′, 22″ may be particularly suitable to receive aqueous pigmented inks (e.g., aqueous latex inks) to generate vivid and sharp images. The flame retardant ink receiving layer(s) 22, 22′, 22″ functions as an ink receiving coating since, during the printing process, ink(s) will be directly deposited thereon. The printed image will have, for instance, enhanced image quality and durability. In some examples, when needed, the printed image can be dried using any drying device attached to a printer such as, for instance, an IR heater.

In some examples of the method 200, printing is accomplished at speeds needed for commercial and other printers such as, for example, HP Latex printers such as 360, 560, 1500, 3200 and 3600 (HP Inc., Palo Alto, Calif., USA).

In some examples, the ink composition is an inkjet ink composition that contains one or more colorants that impart the desired color to the printed image and a liquid vehicle.

As used herein, “colorant” includes dyes, pigments, and/or other particulates that may be suspended or dissolved in an ink vehicle. The colorant can be present in the ink composition in an amount required to produce the desired contrast and readability. In some examples, the ink compositions include pigments as colorants. Pigments that can be used include self-dispersed pigments and non-self-dispersed pigments. Any pigment can be used; suitable pigments include black pigments, white pigments, cyan pigments, magenta pigments, yellow pigments, or the like. Pigments can be organic or inorganic particles as well known in the art.

As used herein, “liquid vehicle” is defined to include any liquid composition that is used to carry colorants, including pigments, to the fabric printable medium 10 disclosed herein. A wide variety of liquid vehicle components may be used and include, as examples, water or any kind of solvents.

In some other examples, the ink composition, applied to the fabric printable medium 10, 10′, 10″ is an ink composition containing latex components. Latex components are, for examples, polymeric particulates dispersed in water. The ink composition may contain polymeric latex particulates in an amount representing from about 0.5 wt % to about 15 wt % based on the total weight of the ink composition. The polymeric latex refers herein to a stable dispersion of polymeric micro-particles dispersed in the aqueous vehicle of the ink. The polymeric latex can be natural latex or synthetic latex. Synthetic latexes are usually produced by emulsion polymerization using a variety of initiators, surfactants and monomers. In various examples, the polymeric latex can be cationic, anionic, nonionic, or amphoteric polymeric latex. Monomers that are often used to make synthetic latexes include ethyl acrylate; ethyl methacrylate; benzyl acrylate; benzyl methacrylate; propyl acrylate; methyl methacrylate, propyl methacrylate; iso-propyl acrylate; iso-propyl methacrylate; butyl acrylate; butyl methacrylate; hexyl acrylate; hexyl methacrylate; octadecyl methacrylate; octadecyl acrylate; lauryl methacrylate; lauryl acrylate; hydroxyethyl acrylate; hydroxyethyl methacrylate; hydroxyhexyl acrylate; hydroxyhexyl methacrylate; hydroxyoctadecyl acrylate; hydroxyoctadecyl methacrylate; hydroxylauryl methacrylate; hydroxylauryl acrylate; phenethyl acrylate; phenethyl methacrylate; 6-phenylhexyl acrylate; 6-phenylhexyl methacrylate; phenyllauryl acrylate; phenyllauryl methacrylate; 3-nitrophenyl-6-hexyl methacrylate; 3-nitrophenyl-18-octadecyl acrylate; ethyleneglycol dicyclopentyl ether acrylate; vinyl ethyl ketone; vinyl propyl ketone; vinyl hexyl ketone; vinyl octyl ketone; vinyl butyl ketone; cyclohexyl acrylate; methoxysilane; acryloxypropyhiethyldimethoxysilane; trifluoromethyl styrene; trifluoromethyl acrylate; trifluoromethyl methacrylate; tetrafluoropropyl acrylate; tetrafluoropropyl methacrylate; heptafluorobutyl methacrylate; butyl acrylate; iso-butyl methacrylate; 2-ethylhexyl acrylate; 2-ethylhexyl methacrylate; isooctyl acrylate; and iso-octyl methacrylate.

In some examples, the latexes are prepared by latex emulsion polymerization and have a weight average molecular weight ranging from about 10,000 Mw to about 5,000,000 Mw. The polymeric latex can be selected from the group consisting of acrylic polymers or copolymers, vinyl acetate polymers or copolymers, polyester polymers or copolymers, vinylidene chloride polymers or copolymers, butadiene polymers or copolymers, polystyrene polymers or copolymers, styrene-butadiene polymers or copolymers and acrylonitrile-butadiene polymers or copolymers. The latex components are in the form of a polymeric latex liquid suspension. Such polymeric latex liquid suspension can contain a liquid (such as water and/or other liquids) and polymeric latex particulates having a size ranging from about 20 nm to about 500 nm or ranging from about 100 nm to about 300 nm.

To further illustrate the present disclosure, an example is given herein. It is to be understood this example is provided for illustrative purposes and is not to be construed as limiting the scope of the present disclosure.

### EXAMPLE

Four examples of the fabric printable medium disclosed herein were prepared. Two examples (E1 and E3) were prepared on fabric A, which was a 100% woven polyester fabric having a base weight of 112 gsm. The polyester yarn strands of fabric A had a 1×1 twill weave. Two other examples (E2 and E4) were prepared on fabric B, which was a 100% woven polyester fabric having a base weight of 140 gsm. The polyester yarn strands of fabric B had a 2×2 simple plan weave. One comparative example fabric medium (C1) was also prepared with fabric A.

All of the fabrics were exposed to scouring, heat setting, and whitening prior to be coated.

Examples E1-E4 were coated with an example of the flame retardant ink receiving layer disclosed herein on the image-side and with an example of the waterproof coating disclosed herein on the back-side. The comparative examples C1 was coated with an example of the flame retardant ink receiving layer, but did not include the waterproof coating.

The ink receiving composition and the waterproofing composition were prepared using a mixer with an impeller, and the formulations are shown in Tables 1 and 2, respectively. The viscosity of both compositions was adjusted to about 20,000 cps at 6 rpm (at 25° C.).

TABLE 1
Flame Retardant Ink Receiving Composition

| Component | Specific | Parts |
|---|---|---|
| Type | Component | (by dry weight) |
| Surface tension | Byk-Dynwet ® 800 | 0.5 |
| control agent | (from BYK) | |
| First polymeric | Sancure ® AU 4010 | 6 |
| network | (from Lubrizol Inc.) | |
| Network | Aradur ® 3985 | 7 |
| crosslinker | (from Huntsman | |
| | International LLC) | |
| Second polymeric | Sancure ® 2026 | 5 |
| network | (from Lubrizol Inc.) | |
| Third polymeric | Araldite ® PZ 3901 | 7 |
| network | (from Huntsman | |
| | International LLC) | |
| Surfactant | Aerosol ® OT-75 | 1 |
| | (from Solvay) | |
| Wetting Agent | Tegowet ® 510 | 0.5 |
| | (from Evonik Ind.) | |
| Antifoamer | Foamaster ® | 1 |
| | (BASF) | |
| Synergist | Antimony trioxide | 10 |
| Brominated flame | Firemaster ® 2100R | 20 |
| retardant | (from LanXESS) | |
| Physical | Tylose ® HS30000 | 0.5 |
| Networking | (from SE Tylose | |
| Agent | GmbH & Co. KG) | |
| Physical | Sterocoll ® FS | 1 |
| Networking | (from BASF) | |
| Agent | | |
| Balance of | Water | Adjust to |
| formulation | | appropriate |
| | | viscosity |

TABLE 2
Waterproofing Composition

| Component | Specific | Parts |
|---|---|---|
| Type | Component | (by dry weight) |
| Waterproof | PHOBOL ® CP-C | 2 |
| agent | (Hunstman | |
| | International LLC) | |
| Physical | Sterocoll ® FS | 1 |
| Networking | (from BASF) | |
| Agent | | |
| Balance of | Water | Adjust to |
| formulation | | appropriate |
| | | viscosity |

A commercial fabric coater with a knife coating station and 8 drying oven and in-line calendering was used to make the examples and comparative examples. The type coatings applied, the coat weights of the applied coatings, and whether or not the sample was subjected to calendering is set forth in Table 3.

TABLE 3

| | | FR Ink | | |
|---|---|---|---|---|
| Example | | Receiving | Waterproof | |
| ID | Fabric | Layer | Coating | Calender |
| E1 | A | Yes - 4 gsm | Yes - 1 gsm | No |
| E2 | B | Yes - 4 gsm | Yes - 1 gsm | No |
| E3 | A | Yes - 4 gsm | Yes - 1 gsm | Yes |
| E4 | B | Yes - 4 gsm | Yes - 1 gsm | Yes |
| C1 | A | Yes - 4 gsm | No | No |

The flame retardant ink receiving composition was coated on the prepared fabric first using a fabric knife coater. Examples E1-E4 were then were coated with the waterproof composition on the back-side. Comparative example Cl did not have the waterproof composition applied thereto. Examples E3 and E4 have same coating design as Examples E1 and E2, but examples E3 and E4 were calendered after coating with an offline soft-nip calender at 75 Kgf/m. The amount of the waterproof composition allowed the composition to coat the polyester yarn strands such that at least some of the voids of the fabric base substrate remained opened after coating. As such, the waterproof coating was a non-continuous, porous coating.

Images were printed on each of the media using latex inks and an HP L-560 printer.

The example media were tested for black optical density, 72 color gamut, ink strike through, dry rub, and fire resistance.

Black optical density measures the black color intensity, and was measured using an X-rite spectrodensitometer from X-Rite Inc. 72 color gamut tests the portion of the color space that is represented or reproduced, and, in this example, was tested using a Gregtag/Mcbeth Spectrolina Spectroscan or a Barberie. The dry rub was tested using a cloth wrapped on one end of solid cylinder surface that comes in contact on the ink and is rubbed back and forth 5 times with certain weight ranging from 180 g to 800 g (Taber Industries, 5750 linear abraser, used coin holder and cloth). These results were given a rating of 5=best (no ink removal) and 1=worst (ink removed). Ink strike through was tested using a visual method or by measuring the optical density (OD) at backside of the printed fabric. When there is no ink strikethrough from the image side to the backside, the score is 5. Score 4 means very minimum amount of ink gets through the fabric thickness to the backside. The score 1 means significant amount ink gets through the fabric thickness. The fire retardance was tested in accordance with NFPA 701 FR test. Table 4 illustrates the results.

TABLE 4

| Example | | 72 Color | Dry | Ink Strike | NFPA |
|---|---|---|---|---|---|
| ID | KOD | Gamut | Rub | Through | FR |
| E1 | 1.2 | ~180K | 3.5 | 4 | Pass |
| E2 | 1.2 | ~180K | 3 | 4 | Pass |
| E3 | 1.3 | ~260K | 4.5 | 4 | Pass |
| E4 | 1.3 | ~260K | 4 | 4 | Pass |
| C1 | 1.2 | ~190K | 3 | 1 | Pass |

As depicted, all of the examples and the comparative example passed the fire test, illustrating that the flame retardant ink receiving layer has suitable fire/flame retardance. The examples including the waterproof coating has improved color gamut and ink strikethrough, illustrating that the waterproof coating disclosed herein improved image quality.

It is to be understood that the ranges provided herein include the stated range and any value or sub-range within the stated range. For example, from about 10 wt % to about 80 wt % should be interpreted to include not only the explicitly recited limits of from about 10 wt % to about 80 wt %, but also to include individual values, such as about 15 wt %, about 44.5 wt %, about 70 wt %, etc., and sub-ranges, such as from about 19 wt % to about 62 wt %, etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise. In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A fabric printable medium, comprising:
a fabric base substrate having an image-side and a back-side;
a flame retardant ink receiving layer on the image-side of the fabric base substrate, the flame retardant ink receiving layer including:
a first crosslinked polymeric network;
a second crosslinked polymeric network;
a flame retardant agent; and
a physical networking agent selected from the group consisting of an acrylate copolymer, a polyacrylic acid copolymer, a polyester copolymer, a polyurethane copolymer, and combinations thereof, the physical networking agent having a weight average molecular weight ranging from 300,000 Mw to 1,000,000 Mw; and
a waterproof coating on the back-side of the fabric base substrate.

2. The fabric printable medium as defined in claim 1 wherein the flame retardant ink receiving layer has a dry coat-weight ranging from about 1 gsm to about 10 gsm.

3. The fabric printable medium as defined in claim 1 wherein the first crosslinked polymeric network and the second crosslinked polymeric network are different and independently selected from the group consisting of polyacrylate, polyurethane, vinyl-urethane, acrylic urethane, polyurethane-acrylic, polyether polyurethane, polyester polyurethane, polycaprolactam polyurethane, polyether polyurethane, alkyl epoxy resin, epoxy novolac resin, polyglycidyl resin, polyoxirane resin, polyamine, styrene maleic anhydride, derivatives thereof, and combinations thereof.

4. The fabric printable medium as defined in claim 1 wherein the flame retardant ink receiving layer further includes a filler, and wherein a dry weight ratio of the filler to the flame retardant agent ranges from about 2 to about 35.

5. The fabric printable medium as defined in claim 4 wherein the filler is selected from the group consisting of ground calcium carbonate, precipitated calcium carbonate titanium dioxide, clay, silica, alumina, and combinations thereof.

6. The fabric printable medium as defined in claim 1, further comprising an outermost ink receiving layer on the flame retardant ink receiving layer, the outermost ink receiving layer including:
the first crosslinked polymeric network;
the second crosslinked polymeric network;
the physical networking agent; and
a filler selected from the group consisting of ground calcium carbonate, precipitated calcium carbonate titanium dioxide, clay, silica, alumina, combinations thereof.

7. The fabric printable medium as defined in claim 1 wherein the flame retardant agent is selected from the group consisting of a mineral compound, a phosphorus-containing compound, a nitrogen-containing compound, a polymeric brominated compound, an organohalogenated compound, an organophosphate compound, alumina trihydrate, and combinations thereof.

8. The fabric printable medium as defined in claim 1, further comprising a second flame retardant ink receiving layer on the waterproof coating.

9. The fabric printable medium as defined in claim 1 wherein the waterproof coating includes:
an other physical networking agent selected from the group consisting of an acrylate copolymer, a polyacrylic acid copolymer, a polyester copolymer, a polyurethane copolymer, and combinations thereof, the physical networking agent having a weight average molecular weight ranging from 300,000 Mw to 1,000,000 Mw; and
a waterproof agent selected from the group consisting of polyvinylidene chloride, a polyolefin, poly(ethylene terephthalate), a wax, perfluorooctane sulfonate, perfluorooctanoic acid, a hydrogen siloxane, a long chain hydrocarbon, and a modified fatty resin.

10. The printable medium as defined in claim 9 wherein:
the fabric base substrate includes yarn strands and voids among the yarn strands; and
the waterproof coating is attached to the yarn strands of the fabric base substrate such that at least some of the voids remain open.

11. A method for forming a fabric printable medium, comprising:
applying an ink receiving composition including:
a first crosslinked polymeric network;
a second crosslinked polymeric network;
a flame retardant agent; and
a physical networking agent selected from the group consisting of an acrylate copolymer, a polyacrylic acid copolymer, a polyester copolymer, a polyurethane copolymer, and combinations thereof, the physical networking agent having a weight average molecular weight ranging from 300,000 Mw to 1,000,000 Mw to an image-side of a fabric base substrate, thereby forming a flame retardant ink receiving layer on the image-side of the fabric base substrate; and
applying a waterproofing composition to a back-side of the fabric base substrate, thereby forming a waterproof coating on the back-side of the fabric base substrate.

12. The method as defined in claim 11 wherein the waterproofing composition includes:
an other physical networking agent selected from the group consisting of an acrylate copolymer, a polyacrylic acid copolymer, a polyester copolymer, a polyurethane copolymer, and combinations thereof, the physical networking agent having a weight average molecular weight ranging from 300,000 Mw to 1,000,000 Mw; and
a waterproofing agent selected from the group consisting of a polyvinylidene chloride emulsion, a polyolefin emulsion, a poly(ethylene terephthalate) emulsion, an aqueous wax emulsion, perfluorooctane sulfonate, perfluorooctanoic acid, a hydrogen siloxane emulsion, a long chain hydrocarbon emulsion, and a modified fatty resin.

13. The method as defined in claim 11 wherein the application of the ink receiving composition involves:
applying a shear force to reduce a viscosity of ink receiving composition as the ink receiving composition is being deposited on the image-side;
removing the shear force to increase the viscosity of the ink receiving composition, whereby the ink receiving composition remains at a surface of the image-side of the fabric base substrate; and
calendering the applied ink receiving composition.

14. The method as defined in claim 11 wherein the waterproofing composition is applied before or after the ink receiving composition is applied.

15. A printing method, comprising:
obtaining a fabric printable medium including:
a fabric base substrate having an image-side and a back-side;
a flame retardant ink receiving layer on the image-side of the fabric base substrate, the flame retardant ink receiving layer including:
a first crosslinked polymeric network;
a second crosslinked polymeric network;
a flame retardant agent; and
a physical networking agent selected from the group consisting of an acrylate copolymer, a polyacrylic acid copolymer, a polyester copolymer, a polyurethane copolymer, and combinations thereof, the physical networking agent having a weight average molecular weight ranging from 300,000 Mw to 1,000,000 Mw; and
a waterproof coating on the back-side of the fabric base substrate; and
applying an ink composition onto the flame retardant ink receiving layer to form a printed image.
